(19) United States
(12) Patent Application Publication
(10) Pub. No.: US 2024/0116663 A1
(43) Pub. Date: Apr. 11, 2024

(54) METHOD FOR PRODUCING A PORTION CAPSULE, AND PORTION CAPSULE

(71) Applicant: Tchibo GmbH, Hamburg (DE)

(72) Inventor: Ralf Müller, Stein AR (CH)

(21) Appl. No.: 17/922,879

(22) PCT Filed: May 6, 2021
(86) PCT No.: PCT/EP2021/062065

§ 371 Date: Nov. 2, 2022

(30) Foreign Application Priority Data
May 8, 2020 (EP) 20173756.6

(51) Int. Cl. B65B 51/22; B29C 65/00; B29C 65/08; B65B 29/02

(52) U.S. Cl. CPC B65B 51/225; B29C 65/08; B29C 66/1312; B29C 66/24244; B29C 66/30223; B29C 66/71; B29C 66/7234; B29C 66/73791; B29C 66/81427; B29C 66/8322; B65B 29/022; B29L 2031/7174

(57) ABSTRACT

A method for producing a capsule, includes providing a base body made of a plastic and having a base region, a circumferential side wall, and a circumferential base body flange adjacent to the circumferential side wall; providing a cover made of a plastic; filling the base body with an extraction material; placing the cover on the base body so that a fastening portion of the cover contacts the base body flange, and fastening the cover flange to the base body flange by ultrasonic welding. When fastening the cover flange, an inner surface of the fastening section makes contact with a flange surface of the base body flange. A sonotrode having mechanical vibrations applied thereto is pressed against an outer surface of the fastening section or of the base body flange, and mechanical vibrations liquefy plastic material of the cover or of the base body flange.

### BACKGROUND OF THE INVENTION

### Field of the Invention

The invention relates to preparing beverages or the like from an extraction material present in a capsule, such as ground coffee. The invention particularly relates to a method for producing a capsule filled with an extraction material and a capsule produced by means of the method.

### Description of Related Art

Extraction devices for preparing beverages from an extraction material present in a portion package are known, for example, as coffee, espresso, or tea machines and continue to enjoy increasing popularity. In many corresponding systems, the portion packages are implemented as capsules in which the extraction material is enclosed in an airtight manner, for example. For extracting, the capsule is pierced at two sides opposite each other. A brewing liquid—typically hot water—is introduced on the first side. The brewed product is discharged from the capsule on the second side. Depending on the beverage to be prepared and the system, a rather substantial pressure must be present in the interior of the capsule. Instead of systems wherein the portion capsule is pierced, there are also systems having capsules already provided with a perforation, the perforation being covered by a protective film, for example, the film being removed or dissolved prior to the brewing process.

Aluminum and plastics, such as polypropylene, have become particularly known as capsule materials. Aluminum capsules bring about very good stability (flavor protection) of the extraction material, but the production thereof is very energy intensive. Polypropylene capsules are advantageous in terms of energy requirements and disposal, but have increased requirements for the piercing mechanism and flavor protection. Both aluminum and plastics are criticized as capsule materials, the former due to high energy consumption in production, and the latter particularly due to the problem of waste.

A coffee portion capsule is known from WO 2010/118543, including approximately a cube shape, made of plastic, and, in contrast to the known cup-shaped capsules, not including a flange on the plane of one (top) cover surface. Such a circumferential flange is necessary for capsule systems according to the prior art for sealing the capsule by means of a film serving as a cover, among other reasons. When sealing by means of ultrasonic welding, the flange is necessary for accommodating an energy director. If the capsule is sealed by means of thermal sealing, then the flange is necessary so that the cover makes contact over a sufficiently large area. In contrast thereto, a domed cover is used according to WO 2010/118543, and the sealing is performed by means of ultrasonic cutting and welding, for example. The capsule produced according to the teaching of WO 2010/118543 therefore, independent of the (“cube”) shape thereof, has a circumferential welding ridge forming only a minimal flange between the planes defined by the cover surface, the extent and lateral protrusion thereof, however, being substantially reduced in comparison with the flange of known capsules.

So-called bio-plastics have also been discussed as capsule materials. Plastics produced from a renewable resource are referred to as such (so-called bio-based plastics). Bio-plastics are also plastics able to be biodegraded (so-called biodegradable plastics). The plastics proposed for producing portion capsules are biodegradable and partially include a portion of bio-based plastics.

In the present text, “biodegradable” means biologically degradable according to the standard EN13432 (version: end of 2019), and “bio-based” means “made from renewable resources, not fossil-based.”

The available bio-plastics, particularly biodegradable plastics, have the property that the plastics soften at relatively low temperatures and thus have a certain flowability already at low temperatures (low glass transition temperature), but that the plastics must be heated to a relatively high point before becoming completely flowable (that is, the melting point, if defined, is not particularly low). This results in particular challenges for welding, because a transition into a very flowable state (above the melting point, if defined) is a prerequisite for reliable welding, so that the span of time during which the material is fundamentally flowable is greater than for conventional plastics.

For producing capsules, therefore, a particular challenge arises for capsules not having a sealing film as a cover, but rather having a plastic body having a three-dimensionally dimensioned shape, for example, as is the case particularly for capsules having shapes as described in WO 2010/118543 or, for example, WO 2015/096990.

### SUMMARY OF THE INVENTION

The object of the present invention is to refine a method for producing capsules, for example of the type described in WO 2010/118543, so as to enable simpler manufacturability when using plastics having a low glass transition temperature, particularly biodegradable and/or bio-based plastics, and to enable reliable sealing of the capsule.

According to one aspect of the invention, a method for producing a capsule includes the following steps:
providing a plastic base body having a base region, a circumferential side wall, and a circumferential base body flange adjacent to the circumferential side wall;
providing a plastic cover for sealing the capsule, that is, for forming a closed capsule together with the base body;
filling the base body with an extraction material;
placing the cover on the base body so that a fastening section of the cover contacts the base body flange;
fastening the cover flange to the base body flange by means of ultrasonic welding;
wherein an inner surface of the fastening section makes area contact with a flange surface of the base body flange when attaching the cover flange, and a sonotrode having mechanical vibrations applied thereto and having an energy director is pressed against an outer surface of the fastening section or of the flange, such that the plastic material of the cover and of the base body flange begins to liquefy, starting at the outer surface, due to the effect of the mechanical vibrations.

That an inner surface of the fastening section makes area contact with a flange surface of the base body flange when fastening the cover flange particularly means that such contact occurs at the point in time at which the energy input is applied or begins. For the procedure according to the prior art, area contact does not occur at any point in time: at the beginning of the ultrasonic welding process according to the prior art, there is no area contact, but rather only contact along the edge defined by the energy director (line contact), and at the end the elements are welded to each other, for which reason no area contact occurs as well.

The effect of this procedure is that a melt develops at first at the outer surface, at the point of contact between the energy director and the plastic material, thus, essentially from the back side. That is, the liquefaction begins at the outer surface (“back side”); the liquefaction occurs at the outer surface first. Material at the outer surface particularly becomes liquid at a point in time while the material at the location of area contact is still solid.

The energy director is then pressed into the plastic material due to the continuous pressure of the sonotrode and the continuous mechanical vibrations. The liquefaction particularly passes quasi through the material of the fastening section or the base body flange. Only as a consequence thereof does a melt form at the boundary between the base body flange and the fastening section, for example in that the melt penetrates from the outer side to the other, inner surface, through the material of the cover or flange. This is in contrast to the prior art, according to which the base body or the cover itself includes an energy director, for which reason a line contact typically results at the beginning between the base body and the cover, wherein the melting of the plastic begins at the energy director and the contact line.

The welding occurs where the cover makes area contact with the flange surface at the beginning of the process, that is, at the location of area contact, and particularly in an area surrounding the line, the position thereof being defined by the energy director of the sonotrode, that is, the line of minimum distance from the edge formed by the energy director. In contract to embodiments wherein the base body flange includes a crimp or the like, into which a sealing film is pressed for sealing the capsule, melting of the materials of the base body flange and of the fastening section takes place particularly along flat surfaces making contact with each other in parallel.

It has been found—surprisingly—that the apparently less efficient procedure having the developing of the melt from the back side produces optimal results for plastics, for example such as bio-plastics, becoming slightly flowable already at relatively low temperatures. For the conventional procedure using energy directors on the plastic for such materials, the resulting weld is often insufficient. One potential explanation for this is that the energy director loses effectivity at an early point in time in the welding process for plastics softening at low temperatures, because the material is too soft and the energy absorption is therefore insufficient. An energy director located further towards the inside can also form a weak point on the plastic, because the material is severely deformed and melted there.

It can be provided particularly that the energy input takes place from the cover side, that is, that the sonotrode is pressed against the fastening section when fastening the cover flange, while the base body is supported in a tool (anvil). It is then the plastic material of the cover that is first liquefied at the outer surface, until the melt has formed at the boundary surface to the base body flange as well, for example in that the melt has penetrated from the outer surface to the point, and material of the flange is also liquefied due to transferred heat. This arrangement, in comparison with the inverse arrangement (effect of the ultrasound from the base body side, that is, from below), is often advantageous, particularly because the base body is filled, and it must be ensured that the filling is not disturbed when the ultrasound acts directly on the base body. The ultrasound acting from below could also cause problems for implementation in practice, because it is not possible to easily size a sonotrode accordingly for reasons of stability.

The energy director on the sonotrode can have the shape of a rib, for example having a V-shaped profile, similar to energy directors for plastic parts to be welded. Such a rib can be disposed circumferentially parallel to the course of the flange. A plurality, for example two, ribs in parallel with each other are also conceivable. Other shapes of energy directors are also conceivable, for example in the form of a circumferential arrangement of individual, hill-like protrusions, etc.

The surface parts of the base body flange contacting each other and the fastening section of the cover can particularly be parallel to each other, resulting in an area contact. The surface parts are particularly free of energy directors or other protrusions or recesses.

In embodiments, an outer section of the common flange arising from the flange of the base body and the fastening section welded thereto is cut off after welding, for example by means of punching. In a group of particular embodiments, this is done in that the region on which the energy director acted during welding—that is, quasi the core region of welding—is also cut off. In other words, the cutting off takes place radially inward of the position of the energy director, that is, closer to the area defined by the circumferential side wall.

The plastic material of the cover and that of the base body can be identical. It is also possible, however, that the cover is made of a plastic having a different composition, but able to be welded to the base body plastic.

The plastic material of the cover and/or of the cup can particularly be a bio-plastic. The material can particularly be a biodegradable plastic. In addition or alternatively, the plastic material can include a bio-based plastic at least in portions.

According to a second aspect, a portion capsule filled with an extraction material is provided accordingly for producing a brewed product, comprising:
a base body made of a biodegradable plastic, having a base region and a circumferential side wall;
a filling of an extraction material or extract, particularly ground coffee beans; and
a cover made of the biodegradable plastic of which the base body is also made and attached to the base body;
wherein the cover is welded to the base body, particularly along a circumferential flange.

The second aspect is based on the insight that, contrary to previous views, a capsule having a cover can also be manufactured and particularly sealed using bioplastics, the cover not being merely a sealing film, but a three-dimensional, rigid body. Fastening can take place particularly by means of the method according to the first aspect.

Such a capsule according to the second aspect can particularly be implemented and produced as described above for the first aspect.

The capsule—for all embodiments, including that of the first aspect—can be particularly implemented so that the base body and the cover together fully enclose the extraction material without any opening covered by a film or the like, for example. The capsule can particularly be hermetically sealed in an oxygen-tight manner, for example by including a suitable diffusion barrier. The capsule can particularly have a rectangular cross section in the shape described in the present text. The cover can particularly—as described in the present text—be variously implemented, from a simple film or plate as a three-dimensional object, and can form an outward dome, for example.

The base body and/or the cover—also applicable to all aspects, as is the below in general—can be produced by means of injection molding or thermomolding. The material can be a commercially typical bio-plastic in embodiments, for example Ecovio by BASF, a compound of a biodegradable polyester (polybutylene adipate-terephthalate) and polylactide.

The base body and cover can particularly include a diffusion barrier layer in addition to the bio-plastic, whereby the capsule is aroma-tight even without outer packaging. An example of a diffusion barrier layer is PVOH (polyvinyl alcohol).

In the embodiments, the base body and/or cover can be present, for example, as a multilayer system using bio-plastics (e.g. Ecovio)/PVOH/bio-plastic, wherein PVOH forms the diffusion barrier layer. Particularly for deep-drawn layer systems, a so-called tie layer, that is, a bonding layer, can also be present between the PVOH layer and the bio-plastic, so that the structure can then be bio-plastic/tie/PVOH/tie/bio-plastic. Biodegradable tie layers have become known and are commercially available, for example as natural waxes.

In the embodiments, the cover is characterized in that the cover forms an outward dome radially inwardly from a circumferential cover flange forming the fastening section during welding, wherein the circumferential cover flange is dimensioned to match the base body flange. The cover according to the present embodiments is thus differentiated from a flat cover element, for example a film or plate-like element.

In general, the cover can be different from a simple film and can be a three-dimensionally formed, particularly rigid body.

The shape of the cover in such embodiments can include, from outside to inside, the cover flange, a curved transition region, and a central flat region forming the actual top cover surface. Such a flat region is offset outwardly from the plane of the cover flange due to the transition region bringing about the dome. The transition region can be curved in an S-shape, for example, or can be constantly curved from an outer part at an angle to the flange plane to a center, flat region. The dimensions thereof are thereby selected, for example, so that the center, flat region dominates optically, in that said region is the same size as or only slightly (e.g. maximum of 10%) smaller than the base area, for example. For an embodiment of the capsule as an overall cuboid or cube shape, it can be provided particularly that the flat region occupies more than 60% of the diameter and accordingly at least 40% of the area.

The cover flange generally forms a circumferential area facing the cover side and extending from an outer edge of the flange to a start of the dome. In the embodiments, it can be provided that the start of the dome is offset inward in comparison with the part of the side wall to which the flange is adjacent. Such an offset can be, for example, a minimum of 0.2 mm.

The base body and/or cover can be produced, for example, by injection molding or a deep-drawing process.

In the embodiments, the base body has a substantially rectangular, for example square, cross section in the region of the flange. The capsule formed from the base body and cover can be approximately cube-shaped, other than the flange remaining after production. The flange itself—for example the outer edge thereof—can also be substantially rectangular, particularly square. ‘Substantially rectangular’ and ‘substantially square’ particularly do not exclude rounded corners; “approximately cube-shaped” also does not exclude rounded edges and corners. The cube shape also does not exclude a slope—caused by the manufacturing process for deep-drawn base bodies, for example—of the circumferential lateral surfaces relative to the axis (perpendiculars on the floor and/or cover area) of a maximum of 3°, for example, particularly a maximum of 2° or a maximum of 1.5°.

It is also possible in the alternative, however, that the base body has a cup shape of the per se known type, having a conical or potentially rotational cylindrical, circumferential side wall.

A wall thickness in the region of the base body is particularly between 0.2 mm and 0.4 mm, for example between 0.25 mm and 0.35 mm. The same can also apply for the wall thickness of the cover. In an embodiment, the wall thickness of the cover corresponds approximately to the wall thickness of the base body.

A capsule to be produced by means of a method according to the first aspect and having an extraction material includes:
a base body made of a plastic, particularly a bio-plastic, having a base region and a circumferential side wall;
a filling of an extraction material or extract, particularly ground coffee beans; and
a cover attached to the base body made of a plastic, particularly a bio-plastic;
wherein the cover is attached to the base body along a circumferential flange,
and the capsule is produced by means of a method of the type described.

The base body flange and/or the cover flange can be provided as oversized. After welding, or simultaneously with welding, the excess regions are then cut off, for example by means of ultrasound or by punching.

### BRIEF DESCRIPTION OF THE DRAWINGS

Embodiments of the invention are described below using drawings. Identical reference numerals in the drawings indicate identical or analogous elements. The drawings are not to scale and partially show corresponding elements in different sizes from figure to figure. Shown are:

FIG. 1 a capsule;

FIG. 2 a base body for producing a capsule according to FIG. 1;

FIG. 3 a cover according to the prior art, shown in section;

FIG. 4 a further cover according to the prior art, also shown in section;

FIG. 5 an arrangement, shown only in details, having a base body, cover, anvil, and sonotrode;

FIG. 6 the arrangement according to FIG. 5 during the ultrasonic welding process; and

FIG. 7 base body and cover welded thereto, also only in details, after the ultrasonic welding procedure and prior to cutting off the outer part of the capsule flange.

### DETAILED DESCRIPTION OF THE INVENTION

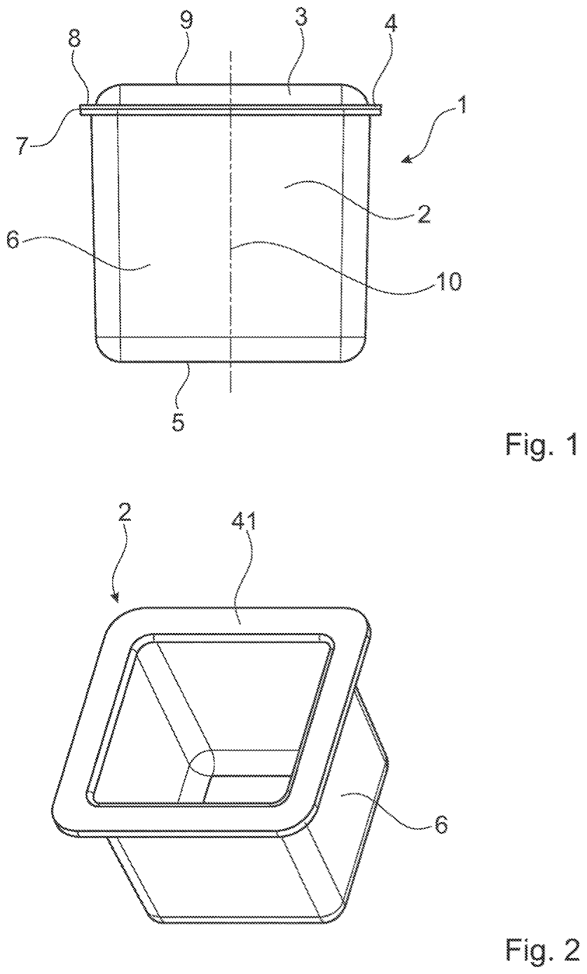

The capsule 1 according to FIG. 1 has substantially the shape of a cube having rounded edges. The extent increases slightly, however, toward the top side, so that the capsule has the shape of a truncated pyramid, from a purely mathematical perspective. The angle of inclination of the lateral surfaces in the figure relative to the perpendicular to the base surface 5—that is, of course, the plane perpendicular to the base surface running through the edge between the base surface and the corresponding lateral surface—is very small, preferably no greater than 2° or only approximately 1°, for example. The height of the capsule above the base surface also approximately corresponds to the length of the base surface edges.

The capsule includes a base body (or cup) 2 and a cover 3 attached thereto along a circumferential flange 4. The base body forms a capsule base 5 and a circumferential side wall 6 closed off by the flange 4 at the outer end thereof with respect to axial directions (axis 10), at the top in the figure. The cover is outwardly domed, in that the cover surface 9 substantially parallel to the capsule base 5 is offset outwardly in comparison with the circumferential flange 4.

FIG. 2 shows the base body 2 (cup) prior to filling and prior to sealing. The base body flange 41 has an extent greater than that of the flange 4 of the finished capsule.

Capsules of the type shown in FIG. 1 and base bodies 2 of the type shown in FIG. 2 are also already known from the prior art, for example from WO 2015/096990.

For producing the capsule, the base body 2 is first filled with the extraction material, then the cover 3 is positioned. Ultrasonic welding then takes place. When using conventional capsule materials, the cover 3 or the base body 2 is provided with an energy director for this purpose in the region of the circumferential flange, for example in the shape of a circumferential rib.

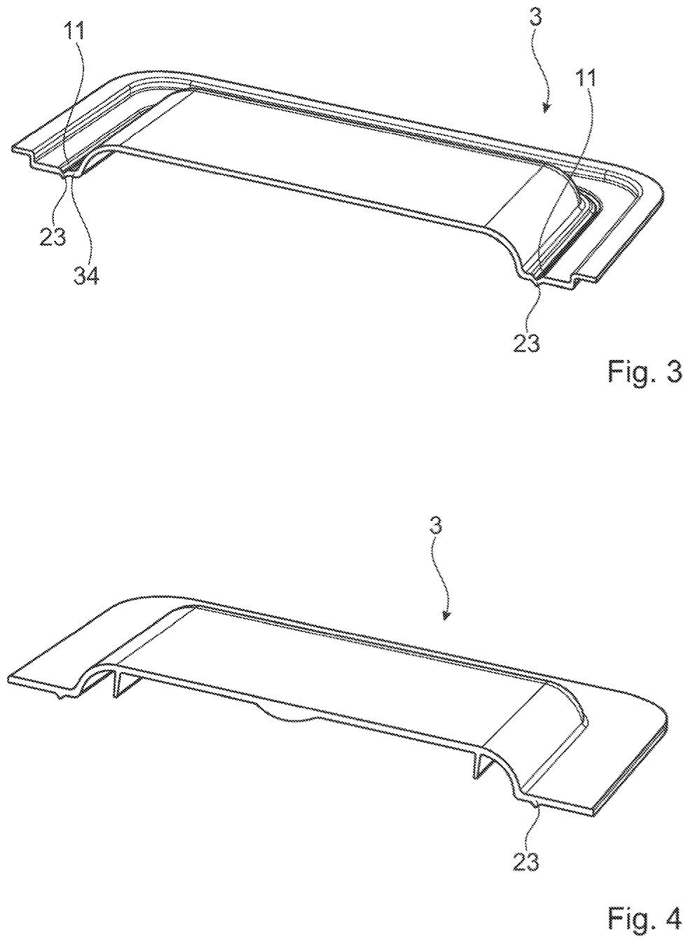

FIGS. 3 and 4 each show one embodiment of a cover 3 according to the prior art. The cover 3 according to FIG. 3 is produced by deep drawing. The energy director 23 formed in the region of the cover flange 34 has the shape of a circumferential rib having approximately a V shape in cross section. A circumferential groove 11 is formed accordingly on the back side (that is, on the outer surface). FIG. 4 shows a cover 3 produced not by deep drawing, but rather by injection molding, having an energy director 23.

It is evident that when using capsule and cover materials already softening at relatively low temperatures, the welding does not always and reliably produce good results when using covers according to FIG. 3 or 4.

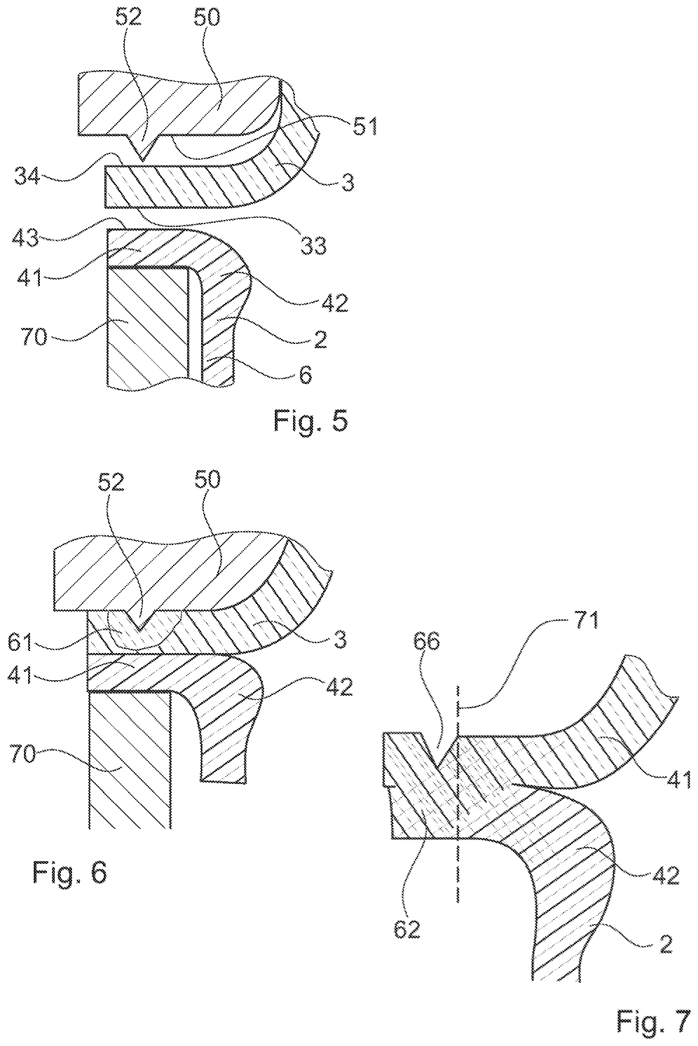

FIGS. 5-7 illustrate the method according to the invention using an example. The base body 2, made of a biodegradable plastic, also includes a circumferential base body flange 41 substantially flat on a top side thereof (flange surface 43), as illustrated in FIG. 2. At the transition between the circumferential side wall 6 and base body flange 41, the base body implements an optional thickening 42 radially inwardly, acting in a reinforcing manner.

The cover 3, like the base body, is rigid and made of the same biodegradable plastic, and includes an inner surface 33, also flat, making area contact with the flange surface 43 for attaching, while the base body flange 41 is supported by an anvil 70. For welding, a sonotrode 50 is pressed against the outer surface 34 of the cover flange and ultrasound is applied. The sonotrode 50 includes an energy director 52. The energy director is implemented by means of the protrusion protruding above the distal active surface 51, namely as a circumferential rib having approximately a V-shaped cross section and forming an edge downward due to said cross-sectional shape.

As illustrated in FIG. 6, the energy input to the sonotrode 50 causes the material of the cover 3 to first be liquefied along the contact with the energy director 52, so that the energy director can penetrate into the material. A melt 61 forms and expands from the location of the energy director due to the continuous applying of energy, and through the material of the cover flange from the back side through to the front side, penetrating into the material of the base body flange. In addition or alternatively, energy absorption can also take place at the boundary between the cover flange and the base body flange. In comparison with the prior art, the resulting welding 62 covers a relatively wide area (see FIG. 7). After removing the sonotrode, an indentation 66 can remain at the location of the energy director.

After welding, a part of the flange protruding radially outward can be cut off, for example by punching, optionally by means of ultrasonic support, ultrasonic cutting, etc. According to one option, this can occur at one point radially inward of the position at which the energy director acted during ultrasonic welding. In FIG. 7, the line 71 indicates the position at which the cutting off takes place. The position is radially inward (that is, to the right in the detail of FIG. 7) of the position of the energy director having left a mark in the form of the indentation 66. The advantage of this solution is that a visually more appealing flange results. The resulting shape at the location of effect of the energy director also cannot always be precisely reproduced. Cutting off brings about that the shape, not always precisely reproducible, is part of the capsule and, in some circumstances, can cause problems when interacting with the brewing chamber during handling and during the brewing process.

1. A method for producing a portion capsule filled with an extraction material for producing a brewed product, comprising the steps of:
providing a base body made of a plastic and having a base region, a circumferential side wall, and a circumferential base body flange adjacent to the circumferential side wall;
providing a cover made of a plastic;
filling the base body with an extraction material;
placing the cover on the base body so that a fastening section of the cover contacts the base body flange; and
fastening the cover flange to the base body flange by ultrasonic welding,
wherein
an inner surface of the fastening section makes area contact with a flange surface of the base body flange when attaching the cover flange, and a sonotrode having mechanical vibrations applied thereto and having an energy director is pressed against an outer surface of the fastening section or of the base body flange, such that the plastic material of the cover and of the base body flange begins to liquefy at the outer surface due to the mechanical vibrations.

2. The method according to claim 1, wherein the sonotrode is pressed against the fastening section when fastening the cover flange, while the base body is supported by a tool.

3. The method according to claim 1, wherein the inner surface of the fastening section and the flange surface of the base body flange are flat and parallel to each other.

4. The method according to claim 1, wherein the energy director is shaped as a circumferential rib.

5. The method according to claim 1, wherein an outer section of a common flange arising from the base body flange and the fastening section welded thereto is cut off after welding.

6. The method according to claim 5, wherein the outer section is cut off so that the region on which the energy director acted during welding is also cut off.

7. The method according to claim 1, wherein the covcr and the base body are made of a same plastic.

8. The method according to claim 1, wherein the cover and/or the base body are made of a biodegradable plastic.

9. The method according to claim 8, wherein the cover and the base body comprise a diffusion barrier layer, for example made of a PVOH.

10. The method according to claim 1, wherein the cover is rigid.

11. The method according to claim 10, wherein the cover forms an outward dome radially inwardly from a circumferential cover flange forming the fastening section during welding.

12. The method according to claim 1, wherein the base body has a substantially rectangular cross section in the region of the base body flange.

13. A portion capsule made of a plastic and filled with an extraction material for producing a brewed product, comprising:
a base body made of a plastic, particularly a bio-plastic, having a base region and a circumferential side wall;
a filling of an extraction material or extract, particularly ground coffee beans; and
a cover made of a plastic, particularly a bio-plastic, and attached to the base body;
wherein the cover is attached to the base body along a circumferential flange,
and wherein the portion capsule is produced by the method according to claim 1.
